(19) United States
(12) Patent Application Publication
(10) Pub. No.: US 2007/0244690 A1
(43) Pub. Date: Oct. 18, 2007

(54) Clustering of Text for Structuring of Text Documents and Training of Language Models

(75) Inventor: Jochen Peters, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/595,829

(22) PCT Filed: Nov. 11, 2004
(86) PCT No.: PCT/IB04/52406

§ 371 Date: Mar. 2, 2007

(30) Foreign Application Priority Data
Nov. 21, 2003 (EP) 03104317.7

(51) Int. Cl. G06F 17/20; G06F 17/27

(52) U.S. Cl. 704/8; 704/9; 704/E17.004

(57) ABSTRACT

The present invention relates to a method, a text segmentation system and a computer program product for clustering of text into text clusters representing a distinct semantic meaning. The text clustering method identifies text portions and assigns text portions to different clusters in such a way that each text cluster refers to one or several semantic topics. The clustering method incorporates an optimization procedure based on a re-clustering procedure evaluating a target function being indicative of the correlation between a text unit and a cluster. The text clustering method makes use of a text emission model and a cluster transition model and makes further use of various smoothing techniques.

The present invention relates to field of clustering of text in order to generate structured text documents that can be used for the training of language models. Each text cluster represents one or several semantic topics of the text.

Text structuring methods and text structuring procedures are typically based on annotated training data. The annotated training data provide statistical information of a correlation between words or word phrases of a text document and semantic topics. Typically a segmentation of a text is performed with respect to the semantic meaning of sections of text. Therefore headings or labels referring to text sections are highlighted by formatting means in order to emphasize and to clearly visualize a section border corresponding to a topic transition, i.e. the position where the semantic content of the document changes.

Text segmentation procedures make use of statistical information that can be gathered from annotated training data. The annotated training data provide structured texts in which words and sentences made of words are assigned to different semantic topics. By exploiting the assignments given by an annotated training data, the statistical information in the training data being indicative of a correlation between words or word phrases or sentences and semantic topics is compressed in the form of a statistical model also denoted as language model. Furthermore, statistical correlations between adjacent topics in the training data can be compressed into topic-transition models which can be employed to further improve text segmentation procedures.

When an unstructured text is provided to a text segmentation procedure in order to generate a structured and segmented text, the text segmentation procedure makes explicit use of the statistical information provided by the language model and optionally also by the topic-transition model. Typically the text segmentation procedure sequentially analyzes words, word phrases and sentences of the provided unstructured text and determines probabilities that the observed words, word phrases or sentences are correlated to distinct topics. If topic-transition models are also used, the probabilities of hypothesized topic transitions are also taken into account while segmenting the unstructured text. In this way a correlation between words or text units in general with semantic topics as well as the knowledge about typical topic sequences is exploited in order to retrieve topic transitions as well as assignments between text sections and predefined topics. A correlation between a word of a text and a semantic topic is also denoted as text emission probability. However, the annotation of the training data for the generation of language models requires semantic expertise that can only be provided by a human annotator. Therefore, the annotation of a training corpus requires manual work which is time consuming as well as rather cost intensive.

U.S. Pat. No. 6,052,657 describes segmentation and topic identification by making use of language models. A procedure is described for training of the system in which a clustering algorithm is employed to divide the text into a specified number of topic clusters {c₁, c₂, . . . cₙ} using standard clustering techniques. For example, a K-means algorithm such as is described in “Clustering Algorithms” by John A. Hartigan, John Wiley & Sons, (1975) pp. 84-112 may be employed. Each cluster may contain groups of sentences that deal with multiple topics. This approach to clustering is merely based in the words contained within each sentence while ignoring the order of the so-clustered sentences.

The present invention aims to provide a method of text clustering for the generation of language models. By means of text clustering, an unstructured text is structured in text clusters each of which referring to a distinct semantic topic.

The present invention provides a method of text clustering for the generation of language models. The text clustering method is based on an unstructured text featuring a plurality of text units, each of which having at least one word. First of all, a plurality of clusters is provided and each of the text units of the unstructured text is assigned to one of the provided clusters. This assignment can be performed with respect to some assignment rule, e.g. assigning a sequence of words of the unstructured text to a certain cluster if some specified keywords are found or if some additional labeling is available before starting the below described clustering procedure. Alternatively, this initial assignment of text units to the provided clusters can also be performed arbitrarily.

Based on this initial assignment of text units to clusters for each of the text units, a set of emission probabilities is determined. Each emission probability is indicative of a correlation between a text unit and a cluster. The entire set of emission probabilities determined for a first text unit indicates the correlation between the first text unit and each of the plurality of provided clusters.

Additionally, transition probabilities are determined indicating whether a first cluster being assigned to a first text unit in the text is followed by a second cluster being assigned to a second text unit in the text. Thereby, the second text unit subsequently follows a first text unit within the text.

For each assignment between a text unit and a cluster, a corresponding transition probability is determined. The transition probability refers to the transition between clusters being assigned to subsequently following text units in the text. Based on the unstructured text, the text units, the emission probabilities and the transition probabilities an optimization procedure is performed in order to assign each text unit to a cluster. This optimization procedure aims to provide an assignment between a plurality of text units to a cluster in such a way that the text units assigned to a cluster represent a semantic entity. Preferably the text emission probabilities are represented by a unigram, whereas the transition probabilities are represented by bigrams.

According to a preferred embodiment of the invention, the optimization procedure comprises evaluating a target function by making use of statistical parameters that are based on the emission and the transition probabilities. These statistical parameters represent word counts, transition counts, cluster sizes and cluster frequencies. A word count is indicative of how often a distinct word can be found in a given cluster. A transition count indicates how often a text unit being assigned to a first topic is followed by a text unit being assigned to a second topic. A cluster size represents the size of a cluster given in the number of words being assigned to the cluster. A cluster frequency finally indicates how often a cluster is assigned to any text unit in the text.

A transition probability from cluster k to cluster l can be derived from the cluster transition count N(cₖ,cₗ), a word emission probability can be derived from a word count N(cₖ,w) indicating how often a word w occurs within the cluster k. The cluster frequency is given by the expression

$$N ( {c}_{k} ) = {\sum }_{l} N ( {c}_{k} , {c}_{l} )$$

counting how often a cluster k can be detected within the entire text and the cluster size is given by

$$Size ( {c}_{k} ) = {\sum }_{w} N ( {c}_{k} , w )$$

representing the number of words assigned to cluster k. Based on these statistical parameters a preferred target function is given by the following expression:

$${\sum }_{k , l} N ( {c}_{k} , {c}_{l} ) \cdot log ( N ( {c}_{k} , {c}_{l} ) ) - {\sum }_{k} N ( {c}_{k} ) \cdot log ( N ( {c}_{k} ) ) + {\sum }_{k , w} N ( {c}_{k} , w ) \cdot log ( N ( {c}_{k} , w ) ) - {\sum }_{k} Size ( {c}_{k} ) \cdot log ( Size ( {c}_{k} ) ) ,$$

where the indices k,l,w run over all available clusters and all words of the text. Since the statistical parameters processed by the target function are all represented in form of count statistics, re-evaluating the target function only incorporates evaluating the few changing count and size terms affected by a re-assignment of a text unit from one cluster to another cluster.

According to a further preferred embodiment of the invention, the optimization procedure makes explicit use of a re-clustering procedure. The re-clustering procedure is based on the initial assignment of text units to clusters for which the statistical parameters word counts, transition counts, cluster sizes and cluster frequencies have already been determined. The re-clustering procedure is based on performing a modification by preliminarily assigning a first text unit which has been previously assigned to a first cluster to a second cluster. Based on this preliminary re-assignment of the first text unit from the first cluster to the second cluster, the target function is repeatedly evaluated with respect to the performed preliminary re-assignment. The first text unit is finally assigned to the second cluster when the result of the target function based on the preliminary re-assignment has improved compared to the corresponding result based on the initial assignment. When in the other case the result of evaluating the target function based on the performed preliminary reassignment has not improved compared to the corresponding result based on the first text unit being assigned to the first cluster, a re-assignment of the first text unit does not take place. In this case the first text unit remains assigned to the first cluster.

The above described steps of preliminary re-assignment, repeated evaluation of the target function and performing the re-assignment of the text unit is performed for all clusters provided to the text clustering method. I.e., after re-assigning the first text unit to a second cluster, it may subsequently be further re-assigned to a third cluster, a fourth cluster and so on. As all clusters are tested the text unit will thus always be assigned to the yet “best” cluster. Furthermore, the preliminary re-assignment, the repeated evaluation, the performing of the re-assignment, the application of the re-clustering procedure with respect to each of the provided clusters is also performed for each of the text units of the unstructured text. In this way a preliminary re-assignment of each text unit with each provided cluster is performed and evaluated and eventually performed as a re-assignment.

According to a further preferred embodiment of the invention, the re-clustering procedure is repeatedly applied until the procedure converges into a final state representing an optimized state of the clustering procedure. For example the re-clustering procedure is iteratively applied until no further re-assignment takes place during the re-clustering procedure. In this way the method provides an autonomous approach to perform a semantic structuring of an unstructured text.

According to a further preferred embodiment of the invention, a smoothing procedure is further applied to the target function. The smoothing procedure can be adapted to a plurality of different techniques, such as a discount technique, a backing-off technique, or an add-one-smoothing technique. The various techniques that are applicable as smoothing procedure are known to those skilled in the art.

Since the discount and the backing off technique require appreciable computational power and are thus resource wasting, the text clustering method is most effective in making use of a smoothing procedure based on the add-one-smoothing technique. Smoothing in general is desirable since a method otherwise may feature the tendency to assign and to define a new cluster for each text unit.

The add-one-smoothing technique makes use of a re-normalization of the word counts and the transition counts. The re-normalization comprises incrementing each word count and incrementing each transition count by one and dividing the incremented count by the sum of all incremented counts in order to obtain probabilities from the so modified counts. In the above exemplary formulas, the terms N(cₖ) and Size(cₖ) are calculated as

$$N ( {c}_{k} ) = {\sum }_{l} N ( {c}_{k} , {c}_{l} ) and Size ( {c}_{k} ) = {\sum }_{w} N ( {c}_{k} , w )$$

based on the modified counts being summed over.

According to a further preferred embodiment of the invention, the method of text clustering comprises a weighting functionality in order to decrease or increase the impact of the transition and emission probability on the target function. This weighting functionality can be implemented into the target function by means of corresponding weighting factors or weighting exponents being assigned to the transition and/or emission probability. In this way the target function and hence the optimization procedure can be adapted according to some predefined preference emphasizing on the text emission probability or the cluster transition probability.

According to a further preferred embodiment of the invention, the smoothing procedure further comprises an add-x-smoothing technique by making use of adding a number x to the word count and adding a number y to the transition count. Corresponding to the add-one-smoothing technique, the incremented word counts and transition counts are normalized by the sum of all counts. In this way the smoothing procedure can further be specified and the smoothing procedure even provides a weighting functionality when the number x added to the word count is substantially different from the number y added to the transition counts.

By increasing the number x, the impact of the word counts underlying the text emission probabilities decreases whereas decreasing the number x results in an increasing impact of the word counts. The number y added to the transition counts features a corresponding functionality on the cluster transition counts. In this way the impact of cluster transition and text emission probabilities can be controlled separately.

According to a further preferred embodiment of the invention, the target function employs the well-known technique of leaving-one-out. Here, each word emission probability is calculated on the basis of a modified count statistics where the count of the evaluated word is subtracted from the word's count within its cluster. Similarly, the probability for a topic transition is calculated on the basis of a modified count statistics where the count of the evaluated transition is subtracted from the overall count of this transition. In this way, an event such as a word or a transition does not “provide” its own count thus increasing its own likelihood. Rather, the complementary counts of all other events (excluding the evaluated event) serve as a basis for a probability estimation. This technique, also known as cyclic cross-evaluation, is an efficient means to avoid a bias towards putting each text unit into a separate cluster. In this way, the method is also able to automatically determine an optimal number of clusters. Preferably, this leaving-one-out technique is applied in combination of any of the above mentioned smoothing techniques.

According to a further preferred embodiment of the invention, a text unit either comprises a single word, a set of words, a sentence, or an entire set of sentences. The size of a text unit can therefore universally be modified. In any case the definition of a text unit, e.g. the number of words or sentences it contains, must be specified. Based on the definition of a text unit, the method of text clustering retrieves document structures or document sub-structures of different size. Since the text clustering method is based on the size of the text units, the computational workload for the calculation of the full target function strongly depends on the number of text units and therefore on the size of the text units for a given text. However, the re-clustering procedure of the present invention only refers to updates of the count statistics due to re-assignments of some text unit which means that major parts of the target function need not to be re-evaluated for each preliminary re-assignment within the re-clustering procedure. For efficiency reasons the changes of the target function can be calculated rather than the full target function itself. Improvements of the target function are thus reflected by positive changes while negative changes indicate a degradation.

According to a further preferred embodiment of the invention, the maximum number of clusters can be specified in order to manipulate the granularity of the text clustering method. In this case the method automatically instantiates clusters and assigns these instantiated clusters to the text units with respect to a maximum number of clusters.

According to a further preferred embodiment of the invention, the optimization procedure further comprises a variation of the number of clusters. In this way an optimum number of clusters can be determined resulting in an optimized result of the target function. In this way the method of text clustering can autonomously determine the optimum number of clusters.

According to a further preferred embodiment of the invention, the method of text clustering can also be performed to weakly annotated text documents, e.g. text documents comprising only a few sections being labeled with corresponding section headings. The method of text clustering identifies the structure of the weakly annotated text as well as assigned section headings and performs a text clustering with respect to the statistical parameters and the detected weakly annotated text structure.

According to a further preferred embodiment of the invention, the method of text clustering can also be performed on pre-grouped text units. In this case each text unit is tagged with some label (e.g. according to some preceding heading from a multitude of headings, many of which may refer to the same semantic topic). Instead of re-assigning each text unit independently to some optimal cluster, the re-assignment is performed for groups of identically tagged units. E.g., when various units are tagged as “Appendix”, these units will always be assigned to the same cluster, and re-assignments take care of keeping them together. In this example, also some other units are conceivable that are tagged as e.g. “Addendum” or “Postscriptum” which might ultimately be assigned to one cluster covering the topic of “supplementary information in some document”.

In the following, preferred embodiments of the invention will be described in greater detail by making reference to the drawings in which:

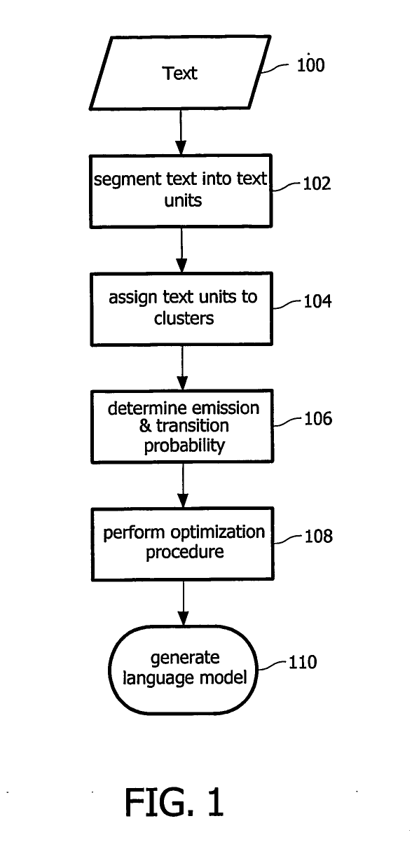

FIG. 1 is illustrative of a flow chart of the text clustering method,

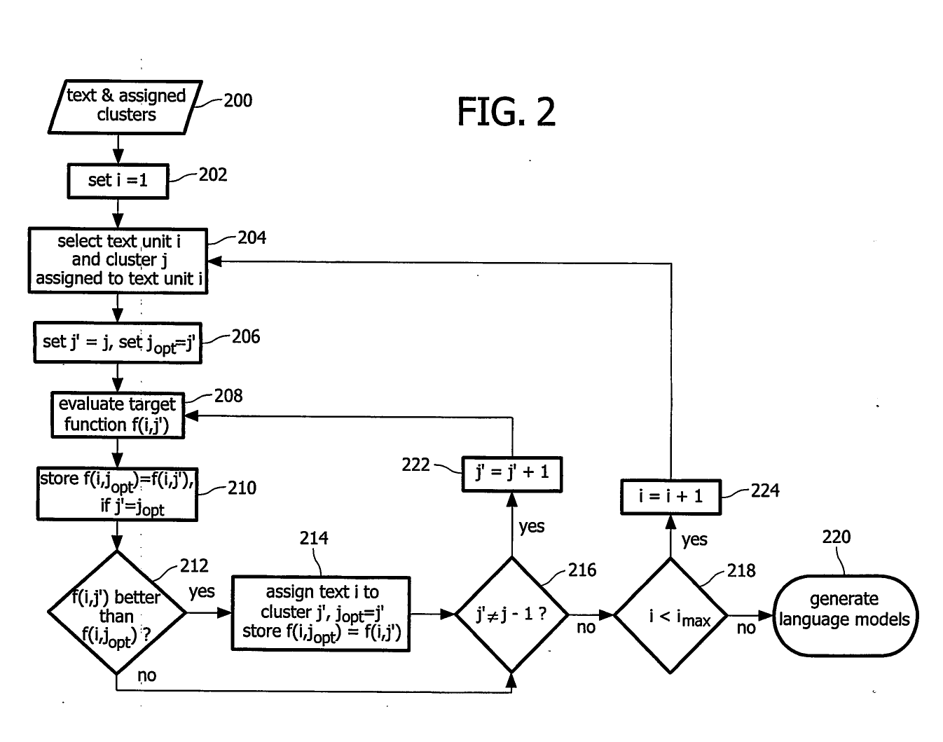

FIG. 2 is illustrative of a flow chart of the optimization procedure,

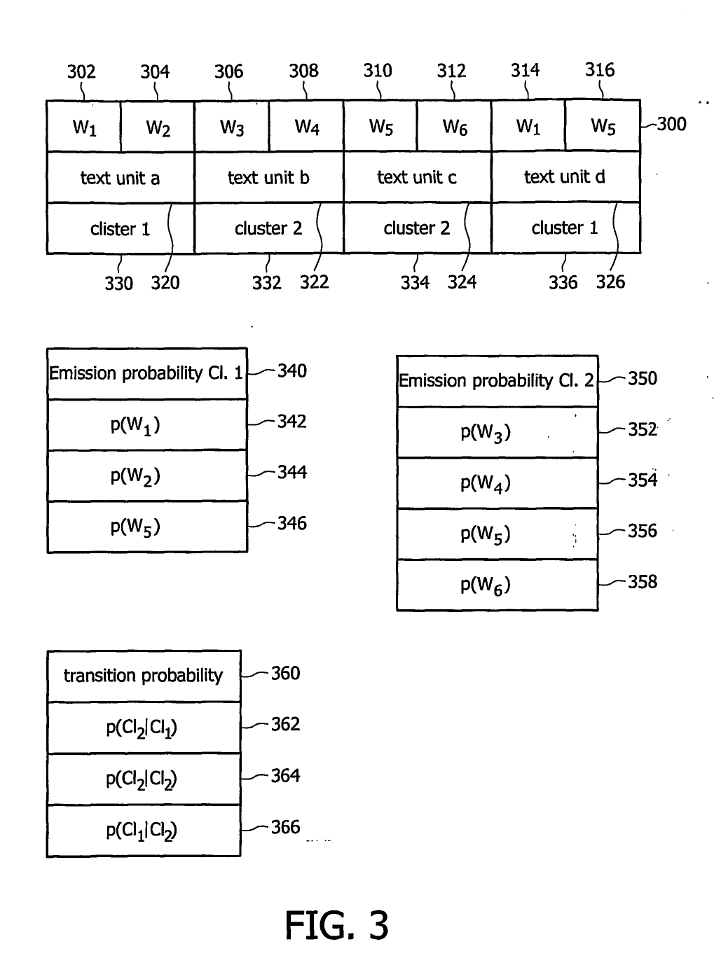

FIG. 3 shows a block diagram illustrating a text comprising a number of words and being segmented into text units and clusters,

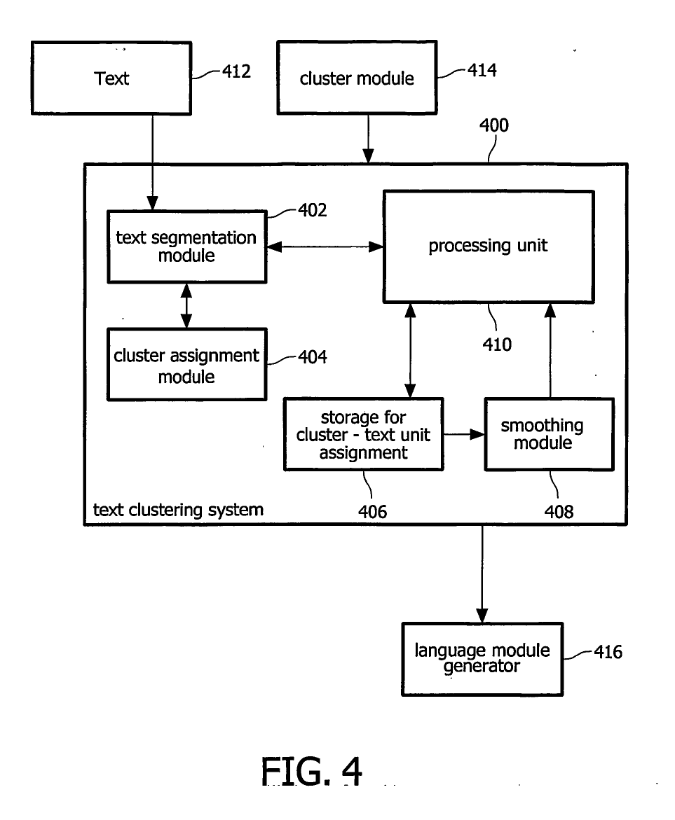

FIG. 4 shows a block diagram of a text clustering system.

FIG. 1 illustrates a flow chart of the text clustering method. In a first step 100 a text is inputted and in a succeeding step 102 the inputted text is segmented into text units. The character of a text unit can be defined in an arbitrary way, i.e. a text unit can comprise only a single word or a whole set of words like a sentence for example. Depending on the size of the chosen text unit, the text clustering method may lead to a finer or coarser segmentation and clustering of the provided text. After the text has been segmented into text units in step 102 in the following step 104 each text unit is assigned to a cluster. This initial assignment can either be performed arbitrarily or in a predefined way. It must only be guaranteed that each text unit is assigned to precisely one cluster.

Based on the initial assignment between text units and clusters, a text emission and a cluster transition probabilities are determined in step 106. The text emission probabilities account for the probability for any given word within each cluster. E.g., when a cluster features a size of 1000 words, and when this cluster contains a distinct word “w” 13 times, then the probability of word “w” within its cluster will be 13/1000 if no smoothing is applied.

The cluster transition probabilities in contrast are indicative of the probability that a first cluster being assigned to a first text unit is followed by a second cluster being assigned to a second text unit directly following the first text unit in the text. (Here, a cluster may be followed by the same cluster or by some different cluster.) Based on the initial assignment of text units and clusters in step 104 and the appropriate text emission and cluster transition probabilities of step 106 the method performs an optimization procedure in step 108.

The optimization procedure makes explicit use of evaluating a target function by making use of the statistical parameters underlying the text emission and cluster transition probabilities. Furthermore the optimization procedure performs a re-clustering of the text by means of re-assigning text units to clusters. The statistical parameters are repeatedly determined and the target function is repeatedly evaluated in order to optimize the result of the target function while the assignment of text units to clusters is subject to modification. When the optimization procedure of step 108 has been performed resulting in a structured text, corresponding language models can be generated on the basis of the clusters found in the structured text in step 110.

FIG. 2 is illustrative of a flow chart of the optimization procedure. In a first step 200 text being initially assigned to clusters is provided. This means that the text is already segmented into text units that are assigned to different clusters. In the next step 202 the text unit index i is set to 1. In the proceeding step 204 the text unit with index i and the assigned cluster with index j are selected. The cluster j refers to the cluster being assigned to the text unit i. Since the assignment between clusters and text units can be arbitrary, the text unit with i=1 is generally not assigned to a cluster with index j=1.

Since the optimization procedure makes use of re-clustering between text units and clusters, the selected text unit i=1 has to be preliminarily assigned to each available cluster. Therefore, a second cluster index j′ is determined in step 206 in order to successively select all available clusters. In step 206 the cluster index j′ equals j and represents the cluster j. Due to this determination of the cluster index j′, an optimum cluster index jₒₚₜ is further instantiated and assigned to the cluster j′, i.e. jₒₚₜ=j′. This optimum cluster index jₒₚₜ serves as a wildcard for that cluster of all available clusters that fits best to the text unit i.

During the following re-clustering procedure j′ is stepwise and cyclically incremented up to j−1 representing the last one of available clusters. Cyclically incrementing refers to a stepwise incrementing procedure of the cluster index j′ from j up to jₘₐₓ followed by the first cluster with index j′=1 and stepwise incrementing the cluster index j′ up to j−1. When for example the cluster with cluster index j=5 is assigned to the first text unit i=1 and when ten different clusters are available, j′ is set to 5 referring to the cluster with j=5. By stepwise and cyclically incrementing of the cluster index j′,j′ represents the sequence of clusters j′=6 . . . 10, 1 . . . 4. In this way, it is guaranteed that starting from an arbitrary cluster index j, each of the available clusters is selected and assigned to the text unit i.

In the succeeding step 208 the target function is evaluated based on the assignment between text unit i and the cluster with index j′. The evaluation of step 208 can be based on calculating changes and modifications of the target function with respect to the results of preceding evaluation of the target function rather than performing a complete re-calculation of the target function.

In the successive step 210, the result of the target function f(i,j′) is stored if j′ equals jₒₚₜ, i.e. f(i,j′)=f(i,jₒₚₜ). Based on the first assignment of jₒₚₜ performed in step 206, a first optimum result of the corresponding target function is stored in step 210. In the next step 212, the result of the evaluation performed in step 208 is then compared with the result of the target function stored in step 210. More specifically in step 212 the result of the target function based on i,j′ is compared with the stored results of the target function based on i,jₒₚₜ. When in step 212 the result of the evaluation of the target function based on the text unit i and the cluster j′ is improved compared to the result of the target function based on the text unit i and the text cluster jₒₚₜ, then in the proceeding step 214, the text unit i is assigned to the text cluster with cluster index j′, jₒₚₜ is redefined as j′ and the result of the target function f(i,j′) is stored as f(i,jₒₚₜ). In this way only such combinations between text units i and clusters j′ are mutually assigned and stored featuring an improved, hence optimized result of the target function compared to an “old” optimum assignment between the text unit i and optimum cluster jₒₚₜ. Therefore the assignment between the text unit i and the cluster jₒₚₜ always represents the best assignment between the text unit i and one of the yet evaluated available clusters j.

In the proceeding step 216 it is checked whether the cluster index j′ already represented all available clusters following the cyclic incrementing up to cluster j′=j−1. When in step 216 the cluster index j′ differs from the last cluster j−1 then in the next step 222 j′ is incremented by 1. After this incrementing of j′ the method returns to step 208 and proceeds in the same way as before with the text cluster j′.

When in the opposite case the target function referring to the cluster j′+1 does not improve in comparison with the target function based on the cluster jₒₚₜ the step 214 is left out. In this case step 216 follows directly after the comparison step 212.

In this way the method performs a preliminary assignment of each text cluster to a given text unit i and determines the text cluster jₒₚₜ leading to an optimum result of the target function. When in step 216 j′ equals j−1, i.e. all available clusters have already been subject to preliminary assignment to text unit i, the method proceeds with step 218 in which the index of the text unit i is compared to the maximum text unit index iₘₐₓ. When i is smaller than iₘₐₓ, the method proceeds with step 224 in which the text unit i is incremented by 1, i.e. the next text unit is subject to preliminary assignment with all available clusters. After this incrementation performed by step 224, the method returns to step 204 in which a text unit i and the assigned cluster j are selected. In the other case when in step 218 the text unit index i is not smaller than iₘₐₓ the modification procedure comes to an end in step 220. In this last step 220 language models can finally be generated on the basis of the performed clustering of the text.

In this way the optimization procedure of the text clustering method comprises two nested loops in order to preliminarily assign each of the text units to each text cluster. For each of these preliminary assignments the target function is evaluated, e.g. by means of determining modifications of the target function, with respect to preceding evaluations and the corresponding results are compared in order to identify optimum assignments between text units and text clusters.

The entire re-clustering procedure can be repeatedly applied until modifications no longer take place. In such a case it can be assumed that an optimum clustering of the text has been performed. Since the evaluation of the target function is based on the statistical parameters (word counts, transition counts, cluster sizes and cluster frequencies), a re-evaluation of the target function with respect to a different cluster comprises only updating the corresponding counts. In this way the re-evaluation of the target function only requires an update of the respective counts and the related terms in the target function instead of a complete recalculation of the entire function.

FIG. 3 shows an example of a text 300 having a number of words 302, 304, 306 . . . 316 being segmented into text units 320, 322, 324 and 326. Each of these text units 320 . . . 326 is assigned to a cluster 330, 332, 334 and 336. In the example considered here, a text unit 320 comprises two words 302 and 304. Word 302 is further denoted as w₁ and word 304 is denoted as w₂. In a similar way word w₅, 310 and word w₆, 312 constitute the text unit 324 which is assigned to a cluster 2, 334.

In the depicted example, the word 314 is identical to the word w₁ 302 and the word w₅ 316 is identical to the word 310. Words 314, 316 constitute the text unit d, 326 that is assigned to cluster 1, 336.

Referring to text unit a, 320 being assigned to cluster 1, 330, the word w₁, 302 as well a the word w₂, 304 are assigned to cluster 1, 330. Referring to text unit d, 326 that is also assigned to cluster 1, 336, the word w₁, 314, as well as the word w₅, 316 are also assigned to the cluster 1, 336.

The table 340 represents the text emission probabilities of text cluster 1, 330, 336. Without smoothing, the non-zero text emission probabilities referring to cluster 1 are p(w₁), 342 p(w₂), 344, and p(w₅), 346. These probabilities are indicative of the words w₁, w₂ and w₅ being assigned to cluster 1, 330, 336. The text emission probabilities 342, 344, 346 are represented as unigram probabilities.

In a similar way, the table 350 represents the text emission probabilities for cluster 2. Here the probabilities p(w₃), 352, p(w₄), 354, p(w₅), 356 and p(w₆), 358 are also represented as unigram probabilities.

Text cluster transition probabilities are represented in table 360. The transition probability p(cluster 2|cluster 1), 362, p(cluster 2|cluster 2), 364 and p(cluster 1|cluster 2), 366 represent cluster transition probabilities in the form of a bigram. The cluster transition probability 362 is indicative of cluster 1, 330 being assigned to text unit 320 is followed by cluster 2, 332 being assigned to a successive text unit 322. The text emission probabilities 342 . . . 346, 352 . . . 358 as well as the text cluster transition probabilities 362 . . . 366 are derived from stored word or transition counts.

FIG. 4 illustrates a block diagram of the text clustering system 400. The text clustering system 400 comprises a text segmentation module 402, a cluster assignment module 404, a storage module for the assignment between text units and clusters 406, a smoothing module 408 as well as processing unit 410. Furthermore a cluster module 414 as well as a language model generator module 416 can be connected to the text clustering system. Text 412 is inputted into the text clustering system 400 by means of the text segmentation module 402. The text segmentation module 402 performs a segmentation of the text into text units. The cluster assignment module 404 then assigns a cluster to each of the text units provided by the text segmentation module. The processing unit 410 performs the optimization procedure in order to find an optimized and hence content specific clustering of the text units. The assignments between text units and clusters are stored in the storage module 406, including storing the word counts per cluster.

A smoothing module 408 being connected to the processing unit provides different smoothing techniques for the optimization procedure. Furthermore the processing unit 410 is connected to the storage module 406 as well as to the text segmentation module 402. The cluster assignment module 404 only performs the initial assignment of the text units to clusters. Based on this initial assignment the optimization and re-clustering procedure is performed by the processing unit by making use of the smoothed models being provided by the smoothing module 408 and the storage module 406. The smoothing module is further connected to the storage module in order to obtain the relevant counts underlying the utilized probabilities. Additionally the cluster module 414 allows to externally determine a maximum number of clusters. When such a maximum number of clusters is specified by the cluster module 414, the initial clustering performed by the cluster assignment module 404 as well as the optimization procedure performed by the processing unit 410 explicitly account for the maximum number of clusters. When finally the optimization procedure has been performed by the text clustering system 400, the clustered text is provided to the language model generator 416 creating language models on the basis of the structured text.

The method of text clustering therefore provides an effective approach to cluster sections of text featuring a high similarity with respect to their semantic meaning. The method makes explicit use on text emission models as well as on text cluster transition models and performs an optimization procedure in order to identify text portions referring to the same semantic meaning.

### LIST OF REFERENCE NUMERALS

300 text
302 word
304 word
306 word
308 word
310 word
312 word
314 word
316 word
320 text unit
322 text unit
324 text unit
326 text unit
330 cluster
332 cluster
334 cluster
336 cluster
340 unigram emission probability table
342 probability
344 probability
346 probability
350 unigram emission probability table
352 probability
354 probability
356 probability
358 probability
360 bigram transition probability table
362 probability
364 probability
366 probability
400 text clustering system
402 text segmentation module
404 cluster assignment module
406 storage
408 smoothing module
410 processing unit
412 text
414 cluster module

1. A method of text clustering for the generation of language models, a text (300) featuring a plurality of text units (320, 322, . . . ), each of which having at least one word (302, 304, . . . ), the method of text clustering comprising the steps of:
assigning each of the text units (320, 322, . . . ) to one of a plurality of provided clusters (330, 332, . . . ),
determining for each text unit a set of emission probabilities (340, 350), each emission probability (342, 344, . . . , 352, 354, . . . ) being indicative of a correlation between the text unit (320, 322, . . . ) and a cluster (330, 332, . . . ), the set of emission probabilities being indicative of the correlations between the text unit and the plurality of clusters,
determining a transition probability (362, 364, . . . ) being indicative that a first cluster (330) being assigned to a first text unit (320) in the text is followed by a second cluster (332) being assigned to a second text unit (322) in the text, the second text unit (322) subsequently following the first text unit (320) within the text,
performing an optimization procedure based on the emission probability and the transition probability in order to assign each text unit to a cluster.

2. The method according to claim 1, wherein the optimization procedure comprises evaluating a target function by making use of statistical parameters based on the emission and transition probability, the statistical parameters comprising word counts, transition counts, cluster sizes and cluster frequencies.

3. The method according to claim 2, wherein the optimization procedure comprises a re-clustering procedure, the re-clustering procedure comprising the steps of:
(a) performing a modification by assigning a first text unit (320) that has been assigned to a first cluster (330) to a second cluster (332),
(b) evaluating the target function by making use of the statistical parameters accounting for the performed modification,
(c) assigning the text unit (320) to the second cluster (332) when the result of the target function has improved compared to the corresponding result based on the first text unit (320) being assigned to the first cluster (330),
(d) repeating steps (a) through (c) for each of the plurality of clusters (330, 332, . . . ) being the second cluster,
(e) repeating steps (a) through (d), for each of the plurality of text units (320, 322, . . . ) being the first text unit.

4. The method according to claim 2, wherein a smoothing procedure is applied to the target function, the smoothing procedure comprising a discount technique, a backing-off technique, or an add-one smoothing technique.

5. The method according to claim 1, comprising a weighting functionality in order to decrease or increase the impact of the transition or emission probability on the target function.

6. The method according to claim 4, wherein the smoothing procedure further comprises an add-x smoothing technique making use of adding a number x to the word counts and adding a number y to the transition counts in order to modify the smoothing procedure and/or the weighting functionality.

7. The method according to claim 2, wherein evaluating of the target function further comprises making use of modified emission (340, 350) and transitions probabilities (360) in form of a leaving-one-out technique.

8. The method according to claim 1, wherein a text unit (320) either comprises a single word (302), a set of words (302, 304, . . . ), a sentence or a set of sentences.

9. The method according to claim 1, wherein the number of clusters (330, 332, . . . ) does not exceed a predefined maximum number of clusters.

10. The method according to claim 1, wherein the text (300) comprises a weakly annotated structure with a number of labels assigned to at least one text unit (320) or to a set of text units (320, 322, . . . ), the method of text clustering further comprising assigning the same cluster to text units having assigned the same label.

11. A computer program product for text clustering for the generation of language models, a text (300) featuring a plurality of text units (320, 322, . . . ), each of which having at least one word (302, 304, . . . ), the computer program product comprising program means for:
assigning each of the text units (320, 322, . . . ) to one of a plurality of provided clusters (330, 332, . . . ),
determining for each text unit a set of emission probabilities (340, 350), each emission probability (342, 344, . . . , 352, 354, . . . ) being indicative of a correlation between the text unit (320, 322, . . . ) and a cluster (330, 332, . . . ), the set of emission probabilities being indicative of the correlations between the text unit and the plurality of clusters,
determining a transition probability (362, 364, . . . ) being indicative that a first cluster (330) being assigned to a first text unit (320) in the text is followed by a second cluster (332) being assigned to a second text unit (322) in the text, the second text unit (322) subsequently following the first text unit (320) within the text,
performing an optimization procedure based on the emission probability and the transition probability in order to assign each text unit to a cluster.

12. The computer program product according to claim 11, wherein the program means for performing the optimization procedure further comprise evaluating a target function by making use of statistical parameters based on the emission and transition probability, the statistical parameters comprising word counts, transition counts, cluster sizes and cluster frequencies.

13. The computer program product according to claim 11, wherein the program means for performing the optimization procedure further comprise program means for re-clustering, the re-clustering program means are adapted to perform the steps of:
(a) performing a modification by assigning a first text unit (320) that has been assigned to a first cluster (330) to a second cluster (332),
(b) evaluating the target function by making use of the statistical parameters accounting for the performed modification,
(c) assigning the text unit (320) to the second cluster (332) when the result of the target function has improved compared to the corresponding result based on the first text (320) unit being assigned to the first cluster (330),
(d) repeating steps (a) through (c) for each of the plurality of clusters (330, 332, . . . ) being the second cluster,
(e) repeating steps (a) through (d), for each of the plurality of text units (320, 322, . . . ) being the first text unit.

14. The computer program product according to claim 12, further comprising program means being adapted to perform a smoothing procedure for the target function, the smoothing procedure comprising a discount technique, a backing-off technique, an add-one smoothing technique or separate add-x and add-y smoothing techniques for the word and cluster transition counts.

15. The computer program product according to claim 11, further comprising program means providing a weighting functionality in order to decrease or increase the impact of the transition or emission probability on the target function.

16. The computer program product according to claim 11, wherein a text unit (320) either comprises a single word (302), a set of words (302, 304, . . . ), a sentence or a set of sentences.

17. A text clustering system for the generation of language models, a text (300) featuring a plurality of text units (320, 322, . . . ), each of which having at least one word (302, 304, . . . ), the text clustering system comprising:
means for assigning each of the text units (320, 322, . . . ) to one of a plurality of provided clusters (330, 332, . . . ),
means for determining for each text unit a set of emission probabilities (340, 350), each emission probability (342, 344, . . . , 352, 354) being indicative of a correlation between the text unit (320, 322, . . . ) and a cluster (330, 332, . . . ), the set of emission probabilities being indicative of the correlations between the text unit and the plurality of clusters,
means for determining a transition probability (362, 364, . . . ) being indicative that a first cluster (330) being assigned to a first text unit (320) in the text is followed by a second cluster (332) being assigned to a second text unit (322) in the text, the second text unit (322) subsequently following the first text unit (320) within the text,
means for performing an optimization procedure based on the emission probability and the transition probability in order to assign each text unit to a cluster.

18. The text clustering system according to claim 17, wherein means for performing the optimization procedure are adapted to evaluate a target function and to perform a re-clustering procedure by making use of statistical parameters based on the emission and transition probability, the statistical parameters comprising word counts, transition counts, cluster sizes and cluster frequencies comprises a re-clustering procedure, the re-clustering procedure comprising the steps of:
(a) performing a modification by assigning a first text unit (320) that has been assigned to a first cluster (330) to a second cluster (332),
(b) evaluating the target function by making use of the statistical parameters accounting for the performed modification,
(c) assigning the text unit (320) to the second cluster (332) when the result of the target function has improved compared to the corresponding result based on the first text unit (320) being assigned to the first cluster (330),
(d) repeating steps (a) through (c) for each of the plurality of clusters (330, 332, . . . ) being the second cluster,
(e) repeating steps (a) through (d), for each of the plurality of text units (320, 322, . . . ) being the first text unit.

19. The text clustering system according to claim 18, further comprising means being adapted to apply a smoothing procedure to the target function, the smoothing procedure comprising a discount technique, a backing-off technique, an add-one smoothing technique or separate add-x and add-y smoothing techniques for the word and cluster transition counts.

20. The text clustering system according to claim 17, wherein a text unit (320) can either comprise a single word (302), a set of words (302, 304, . . . ), a sentence or a set of sentences, the clustering further comprising means being adapted to provide a weighting functionality in order to decrease or increase the impact of the transition and emission probability on the target function.
